(19) United States
(12) Patent Application Publication
(10) Pub. No.: US 2011/0096844 A1
(43) Pub. Date: Apr. 28, 2011

(54) Method for implementing rich video on mobile terminals

(76) Inventors: Olivier Poupel, Rennes (FR); Marin Osmond, Rennes (FR); Stéphane Saada, Rennes (FR); Stéphane Dufosse, Nozay (FR); Valentin Lefevre, Suresnes (FR); Nicolas Livet, Suresnes (FR)

(21) Appl. No.: 12/736,083

(22) PCT Filed: Mar. 13, 2009
(86) PCT No.: PCT/EP2009/053021

§ 371 Date: Dec. 10, 2010

(30) Foreign Application Priority Data
Mar. 14, 2008 (FR) 0801430

(51) Int. Cl. H04N 11/02; H04W 88/02; G06F 15/16

(52) U.S. Cl. 375/240.25; 455/556.1; 709/219; 375/E07.027

(57) ABSTRACT

A communication method comprising the display, on a communication mobile terminal (2) equipped with a camera, a rich video comprising a real filmed scene in which are imbedded additional visual elements connected with said scene, within which video enrichment operations are carried out within a remote communication system (3) and are rendered on the mobile terminal (2) in real time.

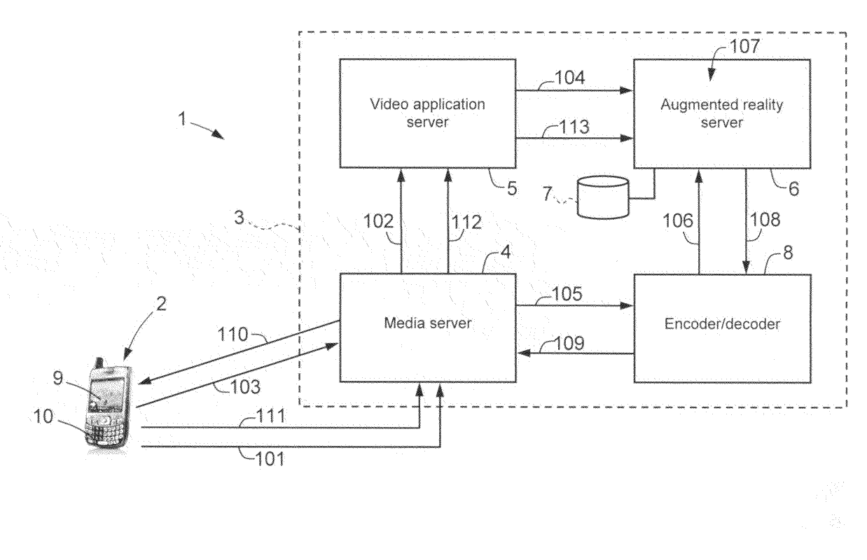

The invention deals with the field of telecommunications, and more specifically to the display of enhanced video on mobile terminals. Although second-generation (2G) mobile networks introduced digital technology into wireless communications, the third generation (3G)—particularly implemented by the UMTS (Universal Mobile Telecommunications System)—ensures the convergence of fixed-line networks and mobile networks by incorporating into mobile networks communication services that had theretofore been reserved for fixed-line networks, particularly owing to the increased bitrates via the air interface (up to 2 Mbit/s). The supported services particularly include (besides voice) audio, video, text, and graphics, i.e. the essential elements of multimedia applications. At the same time, mobile terminals have seen their power increase, and now act like standard computers, which can implement not only persistent applications—which run on the terminal—but also non-persistent applications—which run on a remote server, as the terminal only carries out the playback operations, such as display in video applications (see Pujolle, Les Réseaux, 2008 version, Chap. 43, pp. 1004-1012).

The combined increase of the terminals' power and the bitrates in radio wave communications thereby make it possible to run, on 3G terminals, multimedia applications initially designed for fixed-line networks in which the conventional problems encountered in mobile networks (network accessibility, handover, data transmission time) do not arise. The same holds true for augmented reality, a technique in which virtual elements are displayed superimposed over a scene drawn from reality. One of the applications of augmented reality is enhanced video, in which a filmed scene is enhanced, in real time, with visual elements such as text or images taken from a multimedia database (see for example European patent application EP 1,527,599). This technique has recently appeared in mobile terminals equipped with cameras: see, for example, European patent application EP 1,814,101, or American patent application US 2007/0024527.

However, the proposed solutions have proven unsatisfactory overall. Most of them remain theoretical, and are limited (see the preceding documents) to simple visual elements that do not offer the user real interactivity.

Indeed, the systems described in documents EP 1,814,101 and US 2007/0024527 do not make it possible to integrate augmented reality in real time, meaning within times which are practically undetectable by a user.

The invention is particularly intended to remedy these drawbacks, by offering an enhanced video solution on mobile terminals that may be put into actual practice within mobile networks and which grants users genuine real-time interactivity.

Additionally, the invention aims to be able to adapt to suit most standard mobile terminals.

Finally, the invention aims to grant the user means for interacting with the augmented reality image.

To that end, the invention first proposes a communication method comprising the display, on a communicating mobile terminal equipped with a camera, of an enhanced video comprising a real filmed scene within which are embedded additional visual elements connected with that scene, which method comprises the following operations:
establishment of a media session between the mobile terminal and a remote communication system;
the terminal filming, by means of the camera, a non-enhanced video comprising said real filmed scene;
transmission of the non-enhanced video, in real time, by the mobile terminal to the communication system;
the communication system receiving the non-enhanced video;
a real-time analysis of the filmed scene, within the communication system;
selecting, within a database of the communication system, one or more additional media objects related to the filmed scene;
associating at least one interactive functionality that may be activated from the terminal with at least one object from among said additional media objects;
adding the object or additional media objects thereby selected to the un-enhanced video, in order to form an enhanced video;
the communication system transmitting the enhanced video, in real time, to the mobile terminal;
the mobile terminal playing back, in real time, the enhanced video;
the mobile terminal transmitting to the communication system, in real time, any command made from said terminal through an additional media object with which an interactive functionality had been associated;
the communication system receiving said command operation;
the communication system analyzing the command;
updating the apparent properties of at least one media object within the communication system, in accordance with the command received (for example, according to a pre-established scenario);
the communication system transmitting at least one updated media object, in real time, to the terminal;
the updated media object being played back by the terminal, in real time;
the updated media object being displayed by the terminal, in real time.

Between the receiving of the enhanced video by the communication system and the analysis of the filmed scene, a video decoding operation may be provided, the analysis being carried out from an uncompressed video format.

This command operation is, for example, activated by means of a keyboard of the terminal.

Second, the invention proposes a communication system comprising:
a media server, capable of establishing a media session with a mobile terminal;
a video application server, connected to the media server, and on which is implemented an enhanced video application;
an augmented reality server, connected to the video application server, programmed, upon a command from the video application server, to analyze the images within a non-enhanced video received from the mobile terminal via the media server or a command analysis associated with an additional media object;
a media object database, connected to the augmented reality server.

This system may further comprise an encoder/decoder connected to the augmented reality server and to the media server, configured to decompress a non-enhanced video received from the mobile terminal via the media server, or conversely to compress an enhanced video to be transmitted to the terminal via the media server.

Other objects and advantages of the invention will become apparent upon examining the description below with reference to the attached drawing, which illustrates a network architecture and communication method compliant with the invention.

The network architecture 1 depicted comprises a mobile terminal 2 (a mobile telephone, communicating PDA, or Smartphone), connected, via the air interface, to a communication system 3 comprising a media server 4, which ensures the establishment of media sessions with the terminal 2; a video application server 5, connected to the media server 4 and on which is implemented an enhanced video application, an augmented 6 reality server connected to the video application server 5; and a database 7 within which multimedia objects, connected to or integrated into the augmented reality server 6, are saved.

The term “server” refers here to any information system capable of incorporating functionalities or any computer program capable of implementing a method.

According to one embodiment, the system 3 further comprises an encoder/decoder 8, connected to the augmented reality server 6 and to the media server 4.

The media server 4 and the mobile terminal 2 are configured to establish between themselves media sessions (for example, in accordance with the RTP or H324m protocol), particularly enabling the exchange of audio/video data.

The mobile terminal 2 is equipped with a camera making it possible to produce a simple (meaning non-enhanced) video consisting of a real scene taking place within the terminal's environment, in front of the camera. The terminal is also equipped with a screen 9 enabling the display of video, a keyboard 10 enabling the user to enter commands, a speaker enable sound playback audible at a distance (meaning when the terminal 2 is held at arm's length) or an earpiece for discreet listening.

The data transfer protocols used will preferentially be chosen to obtain a maximum data transmission speed, in order to minimize, from the user's viewpoint, not only the time between when the video is produced from the terminal 2 and the display of the enhanced video, but also the response time to interactions. To the extent that acquisition of a video or processing an image by a server involves an incompressible processing time, it is important that the protocols be fast enough so that the total time taken to receive, process, and send back the data cannot be detected by the user.

The real-time enhancement of a video produced on the terminal 2 is then carried out as follows.

A media session is first established (101) in accordance with a real-time protocol (for example RTP or H324m) between the terminal 2 and communication system 3, and more specifically between the terminal 2 (at its own initiative) and the media server 4. This session is bidirectional by nature, and includes the transmission of audio and video data in real-time, with the outgoing data being encoded (when entering the air interface) and the incoming data being decoded (when exiting the air interface), both by the terminal 2.

The media server 4 then immediately signals (102) to the video application server 5 that this media session is open, so as to order the opening of the enhanced video application.

During the media session established between the terminal 2 and the media server 4, a non-enhanced video, comprising a real filmed scene taking place in front of the camera, is produced from the terminal 2.

This video is transmitted (103), in real time, by the terminal 2 to the media server 3. More precisely, while the scene is being filmed, the video feed is encoded by the terminal 2 in accordance with an appropriate video compression standard (meaning, in practice, adapted to the desired level of compression: thus, for a relatively low level of compression, the terminal may use the H.263 standard; for higher levels of compression, the terminal 2 may employ the MPEG-4 standard, and for very high levels of compression, the H.264 standard) and transmitted by RTP packets to the media server 4. Thus, the flow constantly filmed by the mobile, based on the establishment of the session, is continuously transmitted to the communication 3 system.

Once the media session is established or upon a request from the application server 5 the media server 4 immediately signals the receipt of the first RTP packets of video to the enhanced video application server 5, whose enhanced video application then configures (104) the augmented reality server 6 in anticipation of the operations described below.

The non-enhanced video is transmitted (105) in RTP packets by the media server 4 to the encoder/decoder 8, which compresses it and sends it (106) in real time, in uncompressed format, to the augmented reality server 6. The uncompressed format that is used corresponds, for example to the RFC 4175 standard of the IETF, and uses the RGB (Red Green Blue) or YUV (also known as YCrCb) color definitions.

The augmented reality server 6 then analyzes (107), in real time, the filmed scene included in the video. For example, the video is broken down image by image, then each image is compared with the images from the database 7, by means of an image recognition technique, such as the Harris corner detector technique. An analyzed image is therefore matched one-to-one with an image previously saved within the database 7 and with which is associated at least one media object related with the image's content (and consequently, related with the filmed scene).

This media object, which may be an audio object, a video object, text, or the image (for example, a 3D virtual reality image), or an object using a combination of these resources (for example, an audio/video object) is associated with a predetermined scenario, meaning a rule of correlation with the image of the non-enhanced video at the origin of its selection. For example, if the image of a vehicle is associated in the database, as a media object, with a virtual three-dimensional video of the vehicle's passenger compartment, the scenario may consist of superimposing that view onto an advertising photograph of the vehicle, and to enable the rotation of the view within the space in real time as a function of the terminal's orientation during the filming of the video. To that end, the real-time tracking by the augmented reality server 6 of the relative positions of the camera and the analyzed image then enables the rotation in space of the virtual view synchronized with the camera's orientation.

The terminal 2 may also be equipped with accelerometers whose measurements are included in the RTP flow in real time, in combination with the video data.

The media objects thereby selected are then added (107′) by the augmented reality server 6, in real time, to the non-enhanced video; to form an enhanced video in the uncompressed format.

The enhanced video feed in the uncompressed format is transmitted (108) in real time by the augmented reality server 6 to the encoder/decoder 8, which compresses it in the previously used exchange format (H.263, MPEG-4, H.264), then transmits it (109), also in real time, to the media server 4. This media server then relays (110) the enhanced video to the terminal 2 in real time, which locally ensures decompression and playback in real time.

From the user's viewpoint, the enhancement of the filmed video is done in real time, meaning without any perceptible delay or within a subsecond period. Owing to the speed of information processing allowed by the architecture which has just been described, it is possible to associate the enhanced video's additional media objects with interactive functionalities going beyond a basic adaptation to the movements of the terminal 2, and which may be activated on a voice or manual command by the user, such as by means of keys on the keyboard 10, which may be real or virtual. Each interactive command is transmitted (111) by the terminal 2 to the media server 4, which relays them (112) to the video application server 5, which then orders (113), via its enhanced video application, an update to the apparent properties of the media object within the augmented reality server 6, as a function of the preestablished scenario.

The user may thereby act directly upon the additional object, modifying its properties: color, texture, position, etc., or use functionalities offered by the object itself: playing advertising messages, activating hyperlinks, etc. For example, a user may film a vehicle and receive back a three-dimensional view of the vehicle, which the user may manipulate as desired (rotation, opening the doors, examining the passenger compartment, changing the color, etc.), potentially associated with commercial information that may be interactive: prices, contact information of dealers, delivery times, a link to a commercial website, etc.

In one particular embodiment, some of the functionalities described above are integrated into the mobile terminal 2, in such a way as to reduce the delays due to data transfer times. Thus, the mobile terminal 2 may, for example, incorporate encoding/decoding, so as to send the video flow to the communication system 3 already compressed, and therefore potentially more quickly.

The solution which has just been described thereby proposes an effective application, usable in one's everyday life, of augmented reality, which may be implemented on third-generation mobile terminals without any particular additional functionalities being implemented on them, the majority of the processing being carried out within the remote communication system, whose configuration makes it possible to carry out video enhancement operations in real time.

This solution also makes it possible to access, based on the enhanced video, e-commerce portals.

This method may particularly apply when distributing advertising content intended for a mobile terminal. Indeed, following the analysis of the scene filmed by the mobile terminal 2, the media object additional connected with the filmed scene may be advertising-related.

As a non-limiting example, if the scene filmed by the mobile terminal 2 is a printed poster of a film, the corresponding additional media object may be an advertising video sequence of that film, which may or may not contain the filmed scene. Retrieving that film's screening date, making a reservation, and/or requesting additional information on that film are examples of interactive features that may be associated with the advertising media content and be activated from the mobile terminal 2.

As a second example, if the real scene filmed by the mobile terminal 2 comprises a motor vehicle, several additional advertising media objects may be conceived; such as a piece of advertising content for a new vehicle, accessories, and/or automobile parts or services.

Within this context, the interactive functionalities associated with an additional advertising media object may be for a cultural, informative, and/or commercial purpose.

To the extent that the video enhancement operations are carried out by the communication system 3, this system may also serve to collect information regarding these operations. For example, this information may comprise:
the average duration of a communication session between a mobile terminal 2 and the communication system 3 that deals with a given enhanced video;
the number of communication sessions regarding a given enhanced video, by unit of time;
the number of communication sessions regarding a given enhanced video, by region;
the number of communication sessions already established with users belonging to an initially intended population;
information on the users of the mobile terminals 3 (telephone number, sex, age, last name, first name, etc.)

This information makes it possible to provide very useful statistical data for the owners of additional media objects for a commercial purpose.

1. A communication method comprising the display, on a communicating mobile terminal equipped with a camera, of an enhanced video comprising a real filmed scene within which are embedded additional visual elements connected with said scene, which method comprises the following operations:
establishment of a media session between the mobile terminal and a remote communication system;
the terminal filming, by means of the camera, a non-enhanced video comprising said real filmed scene;
transmission of the non-enhanced video, in real time, by the mobile terminal to the communication system;
the communication system receiving the non-enhanced video;
a real-time analysis of the filmed scene, within the communication system;
selecting, within a database of the communication system, one or more additional media objects related to the filmed scene;
associating at least one interactive functionality that may be activated from the terminal with at least one object from among said additional media objects;
adding the object or additional media objects thereby selected to the un-enhanced video, in order to form an enhanced video;
the communication system transmitting the enhanced video, in real time, to the mobile terminal;
the communication system receiving said command operation;
the communication system analyzing the command;
updating the apparent properties of at least one media object within the communication system, in accordance with the command received (for example, according to a preestablished scenario);
the communication system transmitting at least one updated media object, in real time, to the terminal;
the updated media object being played back by the terminal, in real time;
the updated media object being displayed by the terminal, in real time.

2. A method according to claim 1, which comprises, between the receipt of the video enhanced by the communication system and analysis of the filmed scene, a video decoding operation, analysis being carried out from an uncompressed video format.

3. A method according to claim 1, which comprises a command operation, made from the terminal, of an interaction offered by the media object, and an update operation of the apparent properties of the media object carried out by the communication system as a function of a pre-established scenario.

4. A method according to claim 1, wherein the command operation is activated by means of a keyboard of the terminal.

5. A communication system comprising:
a media server, capable of establishing a media session with a mobile terminal;
a video application server, connected to the media server, and on which is implemented an enhanced video application;
an augmented reality server connected to the video application server, programmed, upon a command from the video application server (6) to carry out an image analysis within a non-enhanced video received from the mobile terminal via the media server or a command analysis associated with an additional media object;
a media object database, connected to the augmented reality server.

6. A communication system according to claim 5, which further comprises an encoder/decoder connected to the augmented reality server and to the media server, configured to decompress a non-enhanced video received from the mobile terminal via the media server, or conversely to compress an enhanced video to be transmitted to the terminal via the media server.
